(19) United States
(12) Patent Application Publication
(10) Pub. No.: US 2018/0261355 A1
(43) Pub. Date: Sep. 13, 2018

(54) CABLE JACKETS

(71) Applicant: SOLVAY SPECIALTY POLYMERS ITALY S.P.A., Bollate (IT)

(72) Inventors: Antonio RUSSO, Milano (IT); Geoffrey Scott UNDERWOOD, Atlanta, GA (US)

(21) Appl. No.: 15/757,010

(22) PCT Filed: Jul. 7, 2016
(86) PCT No.: PCT/EP2016/066072

§ 371 Date: Mar. 2, 2018

Related U.S. Application Data
(60) Provisional application No. 62/213,830, filed on Sep. 3, 2015.

(30) Foreign Application Priority Data
Sep. 30, 2015 (EP) 15187530.9

(51) Int. Cl. H01B 3/30; H01B 7/04; H01B 7/18

(52) U.S. Cl. CPC H01B 3/302; H01B 7/1805; H01B 7/041

(57) ABSTRACT

The present invention relates to a cable jacket made from a fluorinated polyurethane polymer comprising recurring units derived from at least one hydroxy-terminated (per)fluoropolyether polymer.

### CROSS REFERENCE TO RELATED APPLICATIONS

This application claims priority to U.S. provisional application No. 62/213,830 filed on 3 Sep. 2015, and to European application No. 15187530.9 filed on 30 Sep. 2015, the whole content of each of these applications being incorporated herein by reference for all purposes.

### TECHNICAL FIELD

The present invention relates to cable jackets made from a fluorinated polyurethane polymer comprising recurring units derived from (per)fluoropolyethers.

### BACKGROUND ART

Signal transmission cables for transmitting/receiving electric signals generated in acoustic systems or imaging systems may be connected for use with earphones, headphones, speakers, or image display devices. This type of cable has been disclosed for example in US 2014041897 (SUN-KI KIM, JOINSET CO. LTD) and in US 2011051973 (TSINGHUA UNIVERSITY, HON HAI PRECISION INDUSTRY CO., LTD). Sheated electric cables comprising at least one sheat layer made from a plastic material have been also disclosed for example in WO 2010/025963 (COROPLAST FRITZ MUELLER GMBH).

On the other side, Universal Series Bus, generally referred to as “USB”, is an industry standard developed in the mid-1990s that defines the cables, connectors and communication protocols used in a bus for connection, communication, and power supply between computers and electronic devices. This type of cable has been disclosed for example in US 2014/0305675 (HON HAI PRECISION INDUSTRY CO., LTD).

All these cables have an outer sheath, which is also referred to as “cable jacket” or “outermost coating layer”, which encloses all the components of the cable and protects them from the external environment, while at the same time it provides easy handling, flexibility and mechanical strength.

EP 0359272 A (AUSIMONT SRL) discloses polyurethanes comprising rubber-like polyoxyperfluoroalkylene blocks and rigid segments derived from short-chain aliphatic diols and/or aliphatic or aromatic diamines and from (cyclo)aliphatic or aromatic diisocyanates.

### SUMMARY OF INVENTION

The Applicant faced the problem of providing new polymeric materials that can be useful for the manufacture of the cable jacket of a cable, notably earphone cables or USB cables.

The Applicant has surprisingly found that a polyurethane polymer comprising recurring units derived from (per)fluoropolyether polymers has properties, notably stain, chemical and wear resistance, low temperature flexibility, silky feel and mechanical properties, such that it can be used for the manufacture of cable jackets for cables.

In addition, the Applicant has surprisingly found that the cable jackets according to the present invention have improved properties, notably with respect to stain, abrasion and chemical resistance, when compared to cable jackets obtained from fully hydrogenated polyurethanes.

Thus, in a first aspect, the present invention relates to a cable comprising at least one coating layer made from a composition [composition (C)] comprising at least one fluorinated polyurethane [polymer F-TPU], said polymer F-TPU comprising recurring units derived from:

(a) at least one diol selected from the group comprising poly-ether type diol, poly-ester type diol, polybutadien-diol and polycarbonate-diol;

(b) at least one hydroxy-terminated (per)fluoropolyether polymer [PFPE polymer];

(c) at least one aromatic, aliphatic or cycloaliphatic diisocyanate; and

(d) at least one aliphatic, cycloaliphatic or aromatic diol having from 1 to 14 carbon atoms.

In a preferred embodiment, said coating layer is the outermost layer of said cable.

The Applicant has surprisingly found that the outermost coating layer of a cable made from said composition (C) provides a soft silky feeling to the touch, without the addition of plasticizer agents to said composition (C).

### BRIEF DESCRIPTION OF DRAWINGS

FIG. 1 is a cross-sectional view of a first embodiment of a generic cable.

FIG. 2 is a cross-sectional view of an earphone cable.

FIG. 3 is a cross-sectional view of a USB cable.

### DESCRIPTION OF EMBODIMENTS

For the purposes of the present description:
the term “(per)fluoropolyether” is intended to indicate a “fully or partially fluorinated polyether”;
the expression “(per)fluoropolyoxyalkylene chain” is intended to indicate a partially or fully fluorinated, straight or branched, polyoxyalkylene chain;
the use of parentheses before and after symbols or numbers identifying compounds, chemical formulae or parts of formulae has the mere purpose of better distinguishing those symbols or numbers from the rest of the text and hence said parentheses can also be omitted.

Preferably, polymer F-TPU is a block copolymer, i.e. a polymer comprising blocks (also referred to as “segments”), each block comprising recurring units deriving from monomer (a), monomer (b), monomer (c) or monomer (d), as defined above.

Preferably, polymer F-TPU has an average number molecular weight of from 30,000 to about 70,000 Da.

Preferably, polymer F-TPU has a melting point (Tₘ) of from about 120° C. to about 240° C.

Preferably, said at least one monomer (a) has an average number molecular weight of from 500 to 4,000 Da, more preferably of from 1,000 to 4,000.

Preferably, said at least one monomer (a) is selected in the group comprising poly(ethylene)glycol, poly(propylene)glycol, poly(tetramethylen)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol. Poly(tetramethylen)glycol, polycarbonate-diol and poly-caprolactone-diol being particularly preferred.

Preferably, said at least one monomer (b) is a hydroxy-terminated (per)fluoropolyether polymer [PFPE polymer] comprising a (per)fluoropolyoxyalkylene chain [chain (R_{pf})] having two chain ends, wherein one or both chain ends terminates with at least one —OH group.

Preferably, at least one chain end of said chain (R_{pf}) terminates with a group of formula:

—CH₂(OCH₂CH₂)ₜ—OH (I)

wherein

t is 0 or from 1 to 5.

More preferably, both chain ends of said chain (R_{pf}) terminate with a group of formula (I) as defined above.

Preferably, said chain (R_{pf}) is a chain of formula

—(CFX)ₕO(R_{f})(CFX′)₁—

wherein

h and i, equal or different from each other, are equal to or higher than 1, preferably from 1 to 10, more preferably from 1 to 3;

X and X′, equal or different from each other, are —F or —CF₃, provided that when h and/or i are higher than 1, X and X′ are —F;

(R_{f}) comprises, preferably consists of, repeating units R°, said repeating units being independently selected from the group consisting of:

(i) —CFXO—, wherein X is F or CF₃;

(ii) —CFXCFXO—, wherein X, equal or different at each occurrence, is F or CF₃, with the proviso that at least one of X is —F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following : —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

More preferably, chain (R_{f}) is selected from the following formulae (R_{f}-a) to (R_{f}-c):

—(CF₂O)ₙ(CF₂CF₂O)ₘ(CF₂CF₂CF₂O)ₚ(CF₂CF₂CF₂CF₂O)_{q}— (R_{f}-a)

wherein m, n, p, q are 0 or integers selected in such a way as chain R_{f} meets the above number average molecular weight requirement, with the proviso that if, p and q are simultaneously 0, n is not 0; when m is other than 0, the m/n ratio is preferably between 0.1 and 20; when (m+n) is other than 0, (p+q)/(m+n) is preferably between 0 and 0.2;

—(CF₂CF(CF₃)O)ₐ(CF₂CF₂O)_{b}(CF₂O)_{c}(CF(CF₃)O)_{d}— (R_{f}-b)

wherein a, b, c, d are 0 or integers selected in such a way as chain R_{f} meets the above number average molecular weight requirement; with the proviso that, at least one of a, c and d is not 0; when b is other than 0, a/b is preferably between 0.1 and 10; when (a+b) is different from 0 (c+d)/(a+b) preferably is between 0.01 and 0.5, more preferably between 0.01 and 0.2;

—(CF₂CF(CF₃)O)ₑ(CF₂O)_{f}(CF(CF₃)O)_{g}— (R_{f}-c)

wherein e, f, g are 0 or integers selected in such a way as chain R_{f} meets the above number average molecular weight requirement; when e is other than 0, (f+g)/e is preferably between 0.01 and 0.5, more preferably between 0.01 and 0.2.

PFPE polymers wherein chain (R_{f}) complies with formula (R_{f}-a) as defined above, wherein p and q are 0, are particularly preferred in the present invention.

In a preferred embodiment, said PFPE polymer complies with the following formula (PFPE-I):

HO—(CH₂CH₂O)ₜ—CH₂—(R_{pf})—CH₂(OCH₂CH₂)ᵤ—OH (PFPE-I)

wherein

t and u, each independently, are 0 or from 1 to 5 and R_{pf} is as defined above.

Preferably, said polymer PFPE-PAG has an average number molecular weight of from 400 to 10,000 Da, more preferably from 1,000 to 5,000.

In a preferred embodiment, the molar ratio between monomers (a) and monomers (b) is from 2 to 20, more preferably from 2 to 10.

In a preferred embodiment, the amount of monomers (b) is such that the polymer F-TPU comprises from 4 to 30 wt. % of fluorine.

Preferably, said at least one monomer (c) has a number molecular weight of 500 Da or lower, preferably from 10 to 500 Da.

Preferably, said at least one monomer (c) is selected in the group comprising, preferably consisting of, 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate. 4,4′-methylene-diphenylene-di-isocyanate (MDI), 1,6-hexan-diisocyanate (HDI) and hexamaethylen-diisocyanate being particularly preferred.

Preferably, said at least one monomer (d) is selected in the group comprising, preferably consisting of, ethylene-glycol, 1,4-butanediol (BDO), 1,6-hexane diol (HDO), N,N-diethanolamine and N,N-diisopropanolaniline.

BDO and HDO being particularly preferred.

In a preferred embodiment, the sum of blocks deriving from monomers (c) and (d) is from 10 to 60 wt. % based on the total weight of F-TPU polymer.

Those skilled in the art would readily understand that blocks comprising recurring units derived from monomers (a) and (b) are rubber-like blocks, while blocks comprising recurring units derived from monomers (c) and (d) are hard blocks.

In a preferred embodiment, at least 80% of the blocks comprising recurring units derived from monomers (b) are linked [blocks B], at least one of their ends, to a block comprising recurring units derived from monomers (a) [blocks A] through a block comprising recurring units derived from monomers (c) [blocks C].

In other words, at least 80% of blocks B are contained in a sequence of the following type: -[A-C-B-C]-.

Advantageously, polymer F-TPU can be prepared following the procedures disclosed in U.S. Pat. No. 5,332,798 (AUSIMONT S.P.A.), in particular in Example 15.

According to a preferred embodiment, the coating layer is made from a composition (C) that is free of plasticizer agents.

Preferably, said composition (C) comprises the F-TPU polymer as defined above as the main component.

More preferably, said F-TPU polymer is in an amount of at least 60 wt. %, more preferably at least 80 wt %, even more preferably at least 85 wt % based on the total weight of said composition (C).

In addition to the F-TPU polymer, said composition (C) can optionally comprise further additives, such as for example antioxidants, thermal stabilizers, dyestuffs and fillers.

Embodiments wherein said composition (C) is essentially made of said F-TPU polymer in combination with an amount of up to 1 wt. % of any of the additives listed above are also encompassed by the present invention.

Typically, a cable comprises a cable core and at least one coating layer, the cable core comprising at least one metallic inner conductor for transmitting electric signals and, depending on the use for which the cable is intended, further wires.

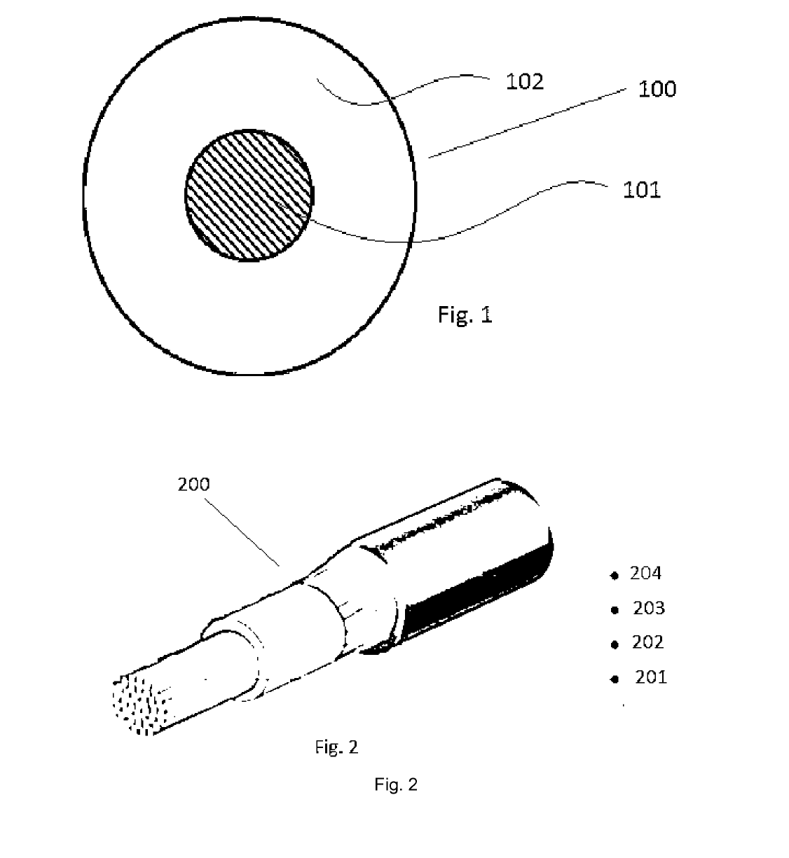

Referring to FIG. 1, a cable 100 according to a first embodiment comprises: a cable core comprising a metallic conductor 101; a coating layer (or jacket) 102, which is the outermost coating layer and is made from a composition (C) comprising the F-TPU polymer as defined above.

Referring to FIG. 2, an earphone cable 200 comprises: a cable core comprising a metallic conductor 201; an insulating layer 202; a shielding layer 203 made from an electro-conductive material; and a coating (or jacket) 204, which is the outermost coating layer and is made from a composition (C) comprising the F-TPU polymer as defined above.

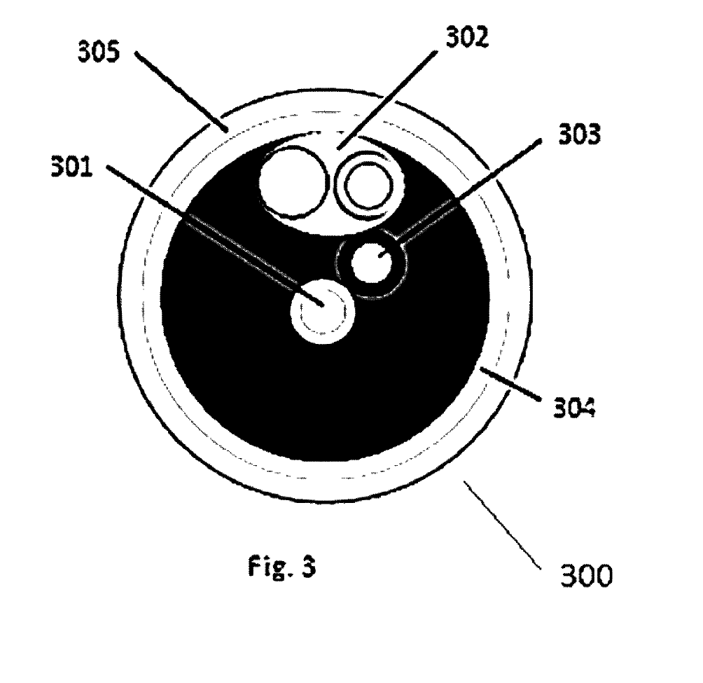

Referring to FIG. 3, a USB cable 300 comprises: a cable core comprising at least one power wire comprising a metallic inner conductor 301 and an insulating layer surrounding the inner conductor (not indicated in the figure), a pair of signal wires 302, a ground wire 303; a metallic braided layer 304; and a coating layer (or jacket) 305, which is the outermost coating layer and is made from a composition (C) comprising the F-TPU polymer as defined above.

The cable jackets according to the present invention can be made following methods known in the art.

As an example, a cable jacket can be manufactured by a process comprising the following steps:

(i) providing a cable comprising at least one cable core comprising at least one metallic conductor;

(ii) coating said cable core with composition (C) comprising at least said F-TPU polymer as defined above.

Preferably, step (ii) is performed by extrusion.

Preferably, after step (ii), step (iii) of cooling down the temperature of the coating layer is performed.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### EXPERIMENTAL SECTION

Materials

Monomers (a):

(a1) polycaprolactonediol (PLC) having molecular weight (Mw) of about 2,000
(a2) polytetramethyleneglycol (PTMEG) having Mw of about 2,000
(a3) polycarbonate-diol (PCD) having Mw of about 2,000
(a4) polyester-diol having Mw of about 2,000

Monomers (b) having general formula:

H(OCH₂CH₂)ₚOCH₂CF₂O(CF₂CF₂O)ₘ(CF₂O)ₙCF₂CH₂O(CH₂CH₂O)ₚH
(b1) p=4.7 and Mw of about 2,000
(b2) p=1.6 and Mw of about 1,700

Monomers (c):
(c1) diphenylen-4,4′-diisocyanate (MDI)
(c2) 1,6-hexan-diisocyanate

Monomers (d):
(d1) 1,4-butanediol (BDO)
(d2) 1,6-hexandiol (HDO)

Catalyst:

bismuth neodecanoate

Preparation of F-TPU Polymer Specimens—Method A

F-TPU polymer specimens in the form of sheet were prepared starting from the abovementioned monomers following the same procedure detailed in Example 15 of U.S. Pat. No. 5,332,798 (to Ausimont S.p.A.) cited above.

F-TPU polymers thus obtained contained 20 wt. % of recurring units derived from monomers (b).

Preparation of F-TPU Polymer Specimens—Method B

F-TPU polymer specimens 5 to 7 and 8 (the latter as comparison) in the form of sheet were prepared as follows:
the hydrogenated pre-polymer was synthetized by reacting monomer (c) and monomer (a) in the equivalent ratio 2 to 1, at a temperature of 90° C.;
the fluorinated pre-polymer was synthetized by reacting monomer (c) and monomer (b) in the equivalent ratio 2 to 1, at a temperature of 90° C.;
the hydrogenated pre-polymer and the fluorinated pre-polymer were then mixed together and stirred at 90° C. for 30 minutes;
monomer (c) was further added depending on the selected stoichiometry;
the reaction was continued at 90° C. for 3 minutes until chain-extension was completed;
the polymer thus obtained was casted at 100° C. for 24 hours.

The compositions of the F-TPU polymers obtained following methods A and B described above and the compositions of comparative hydrogenated polyurethane polymers (H-TPU) are reported in the following Table 1.

As further comparison, a commercially available hydrogenated TPU (H-TPU 9*) was used. The monomers ratio for H-TPU 9* is not publicly available.

TABLE 1

| | Monomers (ratio by mol) | | | | | | | | | |
|---|---|---|---|---|---|---|---|---|---|---|
| | a1 | a2 | a3 | a4 | b1 | b2 | c1 | c2 | d1 | d2 |
| F-TPU 1 | 0.8 | — | — | — | 0.2 | — | 2.0 | — | 1.0 | — |
| F-TPU 2 | — | 0.7 | — | — | 0.3 | — | 3.0 | — | 2.0 | — |
| F-TPU 3 | — | 0.6 | — | — | — | 0.4 | 2.5 | — | 1.5 | — |
| F-TPU 4 | — | — | — | 0.75 | 0.25 | — | — | 2.0 | — | 1.0 |
| F-TPU 5 | 0.75 | — | — | — | — | 0.25 | — | 3.0 | 2.0 | — |
| F-TPU 6 | — | — | 0.75 | — | — | 0.25 | — | 2.0 | 1.0 | — |
| F-TPU 7 | 4.0 | — | — | — | — | 0.3 | — | 0.7 | 3.0 | — |
| H-TPU | — | 1.0 | — | — | — | — | 2.0 | — | 1.0 | — |
| 8(*) | | | | | | | | | | |
| H-TPU | n/a | — | — | — | — | — | — | n/a | n/a | — |
| 9(*) | | | | | | | | | | |

(*)comparison
n/a = value not available

The mechanical properties of sheets made from F-TPU and H-TPU polymers were evaluated and the results are reported in Table 2.

TABLE 2

| | | Tensile | Elongation at |
|---|---|---|---|
| | Shore A | strength (MPa) | break (%) |
| F-TPU 1 | 85 | 28.1 | 471 |
| F-TPU 2 | 93 | 31 | 410 |
| F-TPU 3 | 80 | 35 | 400 |
| F-TPU 4 | 75 | 7.30 | 590 |
| F-TPU 5 | 90 | 26.1 | 505 |
| F-TPU 6 | 83 | 13 | 550 |
| F-TPU 7 | 91 | 31.8 | 506 |
| H-TPU 8(*) | 78 | 40 | 550 |

(*)comparison

The above results show that the F-TPU polymers according to the present invention have mechanical properties comparable with the mechanical properties of H-TPU polymers typically used in the production of the upper of footwear articles, and hence F-TPU polymers provide good mechanical properties to the finished upper.

### EXAMPLE 1

### Contact Angle

This test is considered to be predictive for both stain and chemical resistance.

The static contact angle (SCA) of a sessile drop (about 5 μL) of water and n-hexadecane as solvents was measured with the DSA30 instrument (Krüss GmbH, Germany). The SCA values as well as standard deviations were calculated among ten contact angles.

Surface free energy was calculated following the Owens, Wendt, Rabel and Kaelble method (WORK method), which is a standard method for calculating the surface free energy of a solid from the contact angle with several liquids.

The results are summarized in the following Table 3.

TABLE 3

| Sample | SCA H₂O | SCA C₁₆ | SFE (mN/m) |
|---|---|---|---|
| F-TPU 1 | 104 | 64.5 | 16.1 |
| F-TPU 2 | 110.5 | 63.6 | 15.09 |
| F-TPU 3 | 106.7 | 62.9 | 15.90 |
| F-TPU 4 | 86 | 61 | 23.6 |
| F-TPU 5 | 105 | 68 | 14.9 |
| F-TPU 6 | 103 | 66 | 16 |
| F-TPU 7 | 98 | 70 | 16.9 |
| H-TPU 8(*) | 77 | 46 | 30.93 |
| H-TPU 9(*) | 81 | 29 | 31.7 |

(*)comparison
SCA = Static Contact Angle
H₂O = water
C₁₆ = hexadecane
SFE = Surface Free Energy

The above results show that the contact angle measured with both water (H₂O) and hexadecane (C₁₆) increased while the surface energy dropped down to the range from 15 to 16 mN/m compared to 31 mN/m for the hydrogenated thermoplastic polyurethane used as reference compound. These data are consistent with an increase in terms of stain resistance and chemical resistance conferred by the F-TPUs compared to H-TPU.

### EXAMPLE 2

### Blue Denim Test

This test is considered to be predictive for both staining and abrasion resistance.

The test was performed with the instrument Taber Industries 5750 Linear Abraser, that was set to run at the following conditions:
cycle speed: 30 cycles/min
stroke length: 2.54 cm (1 inch)
number of cycles: 200
total load: 1 kg.

Tests were performed once with dry denim and once with wet denim on F-TPU 1, F-TPU 2, F-TPU 3, F-TPU 5 and F-TPU 7.

Before performing the test with wet denim, denim was submerged in water for 10 second, then it was removed and water was squeezed out by hand so that denim did not drip but was wet to the touch.

The tests were performed as follows: a denim sample measuring approximately 30 mm×30 mm was fixed to a fixture in order to prevent shifting of the sample during the test. A sample of each F-TPU and of H-TPU was then placed on the denim sample and fixed to the fixture as well.

Checkpoints were set as follows:
after rub and
after cleaning with isoproprylalcohol (IPA).

Results for the dry test: no stain was observed for F-TPU 1, F-TPU 2, F-TPU 3, F-TPU 5 and F-TPU 7.

Results for the wet test: a very light halo was observed for F-TPU 1, F-TPU 2, F-TPU 3, F-TPU 5 and F-TPU 7.

### EXAMPLE 3

### Stain Test

A drop of each staining agent listed above was put into contact with the surface of a specimen made from F-TPU 1 and let for 24 hours at ambient conditions. The specimen was then cleaned with water.

A specimen made from H-TPU was used as comparison and treated as disclosed above.

The results are summarized in the following Table 4, wherein:

++=no stain

+=mark/halo

−=stain

TABLE 4

| Staining agent | H-TPU(*) | F-TPU |
|---|---|---|
| Olive oil | − | ++ |
| Ketchup | + | ++ |
| Hot coffee | − | + |
| Mayonaise | − | ++ |
| Coca Cola | − | ++ |
| Mustard | − | + |
| Vinager | ++ | ++ |
| Windex ® cleaner | + | + |
| Formula 409 ® cleaner | + | + |
| Purell ® hand sanitizer | − | ++ |
| Vaseline intensive care lotion | − | ++ |
| Alcohol | − | ++ |

(*)comparison

The above results clearly showed the increase in term of both stain and chemical resistance of the F-TPU specimen compared to the H-TPU specimen.

### EXAMPLE 4

### Evaluation of Haptic Properties

The haptic properties (notably the feeling of softness) of each F-TPU 1, 2 and 3 and H-TPU were measured by testing the sheets of the materials subjectively by hand feel of 5 individuals.

Soft feel was measured subjectively by hand touch and rated on a scale from 1 to 5, with 1 being poor soft feel (hard feel) and 5 being excellent soft feel. Participants took part in this study individually, so they did not influence each other in their responses. Participants were presented with the four samples in a random order and asked to feel and rate them.

The results are summarized in the following Table 5.

TABLE 5

| | Rating | | | | | |
|---|---|---|---|---|---|---|
| | Indi- | Indi- | Indi- | Indi- | Indi- | |
| Sample | vidual 1 | vidual 2 | vidual 3 | vidual 4 | vidual 5 | Average |
| F-TPU 1 | 4 | 5 | 4 | 4 | 5 | 4.4 |
| F-TPU 2 | 5 | 5 | 5 | 4 | 5 | 4.8 |
| F-TPU 3 | 5 | 4 | 4 | 4 | 4 | 4.2 |
| F-TPU 4 | 5 | 5 | 5 | 4 | 5 | 4.8 |
| F-TPU 5 | 5 | 4 | 4 | 3 | 4 | 4.0 |
| F-TPU 6 | 5 | 4 | 5 | 4 | 4 | 4.4 |
| F-TPU 7 | 4 | 4 | 4 | 4 | 5 | 4.2 |
| H-TPU | 2 | 1 | 1 | 1 | 2 | 1.4 |
| 8(*) | | | | | | |
| H-TPU | 2 | 2 | 1 | 1 | 2 | 1.6 |
| 9(*) | | | | | | |

(*)comparison

The above results clearly showed that the sheets obtained with the F-TPUs according to the present invention showed better haptic properties, notably improved feeling of softness, when compared to sheets obtained from H-TPU polymer.

1. A cable comprising at least one coating layer made from a composition (C), said composition (C) comprising at least one fluorinated polyurethane [polymer F-TPU], said polymer F-TPU comprising recurring units derived from:
(a) at least one diol selected from poly-ether type diol, poly-ester type diol, polybutadien-diol and polycarbonate-diol;
(b) at least one hydroxy-terminated (per)fluoropolyether polymer [PFPE polymer];
(c) at least one aromatic, aliphatic or cycloaliphatic diisocyanate; and
(d) at least one aliphatic, cycloaliphatic or aromatic diol having from 1 to 14 carbon atoms.

2. The cable according to claim 1, wherein (a) is selected from poly(ethylene)glycol, poly(propylene)glycol, poly(tetramethylene)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol.

3. The cable according to claim 1, wherein (b) is a hydroxy-terminated (per)fluoropolyether polymer [PFPE polymer] comprising a (per)fluoropolyoxyalkylene chain (R_{pf}) having two chain ends, wherein one or both chain ends terminates with at least one —OH group.

4. The cable according to claim 3, wherein at least one chain end of said chain (R_{pf}) bears a group of formula (I):
—CH₂(OCH₂CH₂)ₜOH (I)
wherein
t is 0 or from 1 to 5.

5. The cable according to claim 4, wherein both chain ends of said chain (R_{pf}) bear a group of formula (I) as defined in claim 4.

6. The cable according to claim 3, wherein said chain (R_{pf}) is a chain of formula
—(CFX)ₕO(R_{f})(CFX′)ᵢ—
wherein
h and i, equal or different from each other, are equal to or higher than 1, preferably from 1 to 10, more preferably from 1 to 3;
X and X′, equal or different from each other, are —F or —CF₃, provided that when h and/or i are higher than 1, X and X′ are —F;
(R_{f}) comprises repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

7. The cable according to claim 6, wherein said chain (R_{f}) is a chain selected from chains of formulae (R_{f}-a) to (R_{f}-c):
—(CF₂O)ₙ(CF₂CF₂O)ₘ(CF₂CF₂CF₂O)ₚ(CF₂CF₂CF₂CF₂O)_{q}— (R_{f}-a)
wherein m, n, p, q are 0 or integers selected in such a way that chain R_{f} meets the above number average molecular weight requirement, with the proviso that if p and q are simultaneously 0, n is not 0;
—(CF₂CF(CF₃)O)ₐ(CF₂CF₂O)_{b}(CF₂O)_{c}(CF(CF₃)O)_{d}— (R_{f}-b)
wherein a, b, c, d are 0 or integers selected in such a way that chain R_{f} meets the above number average molecular weight requirement; with the proviso that at least one of a, c and d is not 0;
—(CF₂CF(CF₃)O)ₑ(CF₂O)_{f}(CF(CF₃)O)_{g}— (R_{f}-c)
wherein e, f, g are 0 or integers selected in such a way that chain R_{f} meets the above number average molecular weight requirement.

8. The cable according to claim 1, wherein (c) is selected from 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyana-te, hexamaethylen-diisocyanate, isophorone-diisocyanate, 4,4′-dicyclohexyl-methane-diisocyanate and cyclohexyl-1,4-diisocyanate.

9. The cable according to claim 1, wherein (d) is selected from ethylene-glycol, 1,4-butanediol (BDO), 1,6-hexane diol (HDO), N,N-diethanolamine and N,N-diisopropanolaniline.

10. The cable according to claim 1, wherein at least 80% of the blocks comprising recurring units derived from (b) are linked, at least one of their ends, to a block comprising recurring units derived from (a) through a block comprising recurring units derived from (c).

11. The cable according to claim 1, wherein said coating layer is the outermost layer of said cable.

12. The cable according to claim 1, wherein said composition (C) that is free of plasticizer agents.

13. The cable according to claim 1, wherein said cable is an earphone cable.

14. The cable according to claim 1, wherein said cable is a USB cable.

15. The cable according to claim 7, wherein chain (R_{f}) is a chain selected from chains of formula (R_{f}-a) and wherein, when m is other than 0, the m/n ratio is between 0.1 and 20; when (m+n) is other than 0, (p+q)/(m+n) is between 0 and 0.2.

16. The cable according to claim 7, wherein chain (R_{f}) is a chain selected from chains of formula (R_{f}-b) and wherein, when b is other than 0, a/b is between 0.1 and 10; when (a+b) is different from 0, (c+d)/(a+b) is between 0.01 and 0.5.

17. The cable according to claim 7, wherein chain (R_{f}) is a chain selected from chains of formula (R_{f}-c) and wherein, when e is other than 0, (f+g)/e is between 0.01 and 0.5.

18. The cable according to claim 1, wherein
(a) is selected from poly(ethylene)glycol, poly(propylene)glycol, poly(tetramethylene)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol;
(b) is a hydroxy-terminated (per)fluoropolyether polymer [PFPE polymer] comprising a (per)fluoropolyoxyalkylene chain (R_{pf}) having two chain ends, wherein one or both chain ends terminates with at least one —OH group;
(c) is selected from 4,4′-methylene-diphenylene-di-isocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate; and
(d) is selected from ethylene-glycol, 1,4-butanediol (BDO), 1,6-hexane diol (HDO), N,N-diethanolamine and N,N-diisopropanolaniline.
